(19) United States
(12) Patent Application Publication
(10) Pub. No.: US 2012/0213527 A1
(43) Pub. Date: Aug. 23, 2012

(54) OPTOELECTRONIC DEVICE FOR BIDIRECTIONALLY TRANSPORTING INFORMATION THROUGH OPTICAL FIBERS AND METHOD OF MANUFACTURING SUCH A DEVICE

(76) Inventors: Richard Laurentius Duijn, Eindhoven (NL); Maurice Martinus De Laat, Budel (NL); Gerard Nicolaas Van Den Hoven, Maria Hoop (NL)

(21) Appl. No.: 13/395,559

(22) PCT Filed: Sep. 2, 2010
(86) PCT No.: PCT/EP2010/062875

§ 371 Date: May 8, 2012

(30) Foreign Application Priority Data
Sep. 15, 2009 (NL) 2003498

(51) Int. Cl. H04B 10/14; G02B 6/42

(52) U.S. Cl. 398/139; 29/592.1

(57) ABSTRACT

An optoelectronic device for bidirectionally transporting information through glass fibers between logically distributed users and a central station by means of transceivers of said central station. In particular, a set of several glass fibers (32) is connected in an array having a predetermined pitch to a multiple-operation coupling element (36) that is provided with lenses and that guides the downstream and upstream radiations from the glass fibers through a multiple-operation wavelength divider (40) which effects a spatial separation between the downstream and upstream radiations such that said downstream and upstream radiations are imaged on radiation sources (44) and photodetectors (46), respectively, said radiation sources being spatially separated from said photodetectors.

The invention relates to an optoelectronic device for bidirectionally transporting information through glass fibers by means of (electromagnetic) radiation between distributed users and a central station using transceivers in or adjacent to the central station as defined in the pre-characterizing section of claim 1. Such devices are used, for example, in communication networks operating in accordance with the “fiber to the home” principle, wherein a judicious choice has to be made from a large number of compromises for the “final mile”. The users may be physically joined together into larger bundles that each form a sub-unit, if so desired, or be realized as individual subscribers.

The invention has for its object to provide an integration of several bidirectional transceivers into a single module. Each individual transceiver comprises a radiation source and a photodetector. A bidirectional transceiver adds a wavelength separator thereto so as to render possible a downstream and an upstream communication through a single glass fiber. It is noted that wherever the term “glass fiber” is used herein, this relates to the practice of everyday speech. Fibers of glass may be used, but so may be fibers of alternative materials such as quartz or possibly synthetic resin materials.

Crucial parameters are in particular the required volumes of the equipment, the production cost, and the operational power consumption. According to certain transmission parameters, a band of 1260-1360 nm is used for upstream and one of 1480-1580 or 1480-1500 nm for downstream transmission (in accordance with standard IEEE 802.3ah). Typical production cost figures are 50% for the components of the transceivers and 50% for packaging, the power consumption of one transceiver is, for example, approximately 1 W, and the dimensions of one module are of the order of ½×1×5 cm.

The alignment of the various components in the manufacture of modules for, for example, 12 glass fibers is highly critical. Especially the dimensions of (the active regions of) radiation sources such as lasers are of the order of only a few μm. The active region of a photodetector on the on the other hand is comparatively large, for example of the order of 50 μm. It is accordingly advantageous to use a comparatively large surface area thereof for the detection of received radiation. The inventors have realized that the physically fixed arrangement of the radiation sources and the photodetectors relative to one another and the lengthening of the radiation path to the detectors render the design of the device a causal one, so that the photodetectors can be aligned in an inherent manner.

According to the invention, a spatial separation is achieved between downstream and upstream colors, after which separation the radiation is transported further.

### SHORT DESCRIPTION OF THE INVENTION

It is accordingly an object of the invention inter alia to provide a coupling of the spatial arrangement of the radiation sources to that of the photodetectors such that the manufacture of the multiply integrated transceivers becomes causal.

To achieve this object, the invention in one of its aspects is characterized in that a set of several glass fibers is connected in an array having a predetermined pitch to a multiple-operation coupling element that is provided with lenses so as to guide the downstream and upstream radiations from the glass fibers through a multiple-operation wavelength divider which effects a spatial separation between the downstream and upstream radiations such that said downstream and upstream radiations are imaged on spatially separated radiation sources and photodetectors as defined in the characterizing part of claim 1. The embodiments described below may be used to advantage for constructing multiple transceiver systems. It is noted that the word “lenses” is used herein in its everyday meaning “Lenses” may be any systems with an optical lens function such as, for example, traditional lenses and focusing mirrors.

A device is known per se from U.S. Pat. No. 6,736,553 wherein an alignment is provided between an optical member and elements of a sub-module, but in this construction there is no two-way traffic through a single optical waveguide. In the case of “fiber to the home”, which typically involves a two-way or bidirectional traffic through a single optical waveguide, this technology can accordingly not be used.

According to a preferred embodiment, said radiation sources and/or photodetectors are arranged on an optical platform which forms part of a photo-electrical connection element for said central station. The photo-electrical connection element at the same time provides the electrical connection to the central station. This leads to a compact construction, especially if said radiation sources and photodetectors are mutually inherently aligned in said array. In many cases all that is required is to align two channels of the radiation sources in order to realize a complete XY fit.

According to a preferred embodiment of the invention, said radiation sources and photodetectors are fixed on a carrier at fixed and substantially uniform distances to one another. The accommodation in a mechanical arrangement is often simplified thereby.

According to a preferred embodiment of the invention, said radiation sources and photodetectors are fixed together on a carrier so as to lie substantially in one plane. The accommodation in a mechanical arrangement is often simplified thereby.

According to a preferred embodiment of the invention, said radiation sources are constructed as vertical lasers. This is found to result in a simple configuration in many cases.

According to a preferred embodiment of the invention, the radiation sources are located substantially in the focal points of the respective lenses, while the associated photodetectors are located out of focus, i.e. further removed than said focal points. The dimension of the detection radiation spot is adapted to available detectors in this manner.

According to a preferred embodiment of the invention, waveguides are arranged in the wavelength separating element in the direction of the photodetectors. This has the advantage that the radiation sources and photodetectors can be placed at a comparatively great distance from one another, the dimension of the radiation spot no longer being the limiting factor.

According to a preferred embodiment of the invention, focusing mirrors are arranged between the wavelength separator and the photodetectors. This provides the same advantage of easy dimensioning.

According to a preferred embodiment of the invention, the wavelength separator comprises, optically connected in series in that order, a filter relative to a first wavelength and a mirror relative to a second wavelength, and the radiation beams issuing from or entering the wavelength separator are substantially perpendicular to a mounting surface of the radiation sources and photodetectors. A filter may obviously be used instead of the mirror, hence the word “mirror” also covers a filter herein. In a favorable modification of this embodiment, the wavelength separator is at an oblique angle to said radiation beams and said mounting surface. This renders it easy to manufacture not only the device itself in a simple and reliable manner, but also components thereof, such as in particular the wavelength separator.

The invention also relates to a method of manufacturing a device as described above. Such devices can be readily and inexpensively produced and are used on an extensive scale in present-day communication networks.

Various advantageous aspects of the invention are recited in the dependent claims.

### SHORT DESCRIPTION OF THE DRAWING

The above and further properties, aspects and advantages of the invention will now be described in more detail below with reference to preferred embodiments of the invention and with reference especially to the appended Figures, in which:

FIG. 1 is a three-dimensional view of an array in which the invention is realized;

FIG. 2 shows a 12-fold MPO connector with MT ferrule;

FIG. 3 shows an optical coupling element with a 90° mirror angle;

FIG. 4 shows an optical coupling element with a rectilinear beam path;

FIGS. 5a, 5b show two embodiments of a micro-optical wavelength separator;

FIG. 6 is a plan view of an optical platform;

FIG. 7 shows a difference in height between radiation source and detector;

FIG. 8 shows waveguides 91 in the micro-optical wavelength separators;

FIG. 9 shows a lens system 112 between the wavelength separator and wave-guiding fibers;

FIG. 10 shows a discrete lens array 113 between the wavelength separator and radiation source/detector, serving at the same time as an optical platform;

FIG. 11 shows a focusing mirror for the received radiation;

FIG. 12 depicts the use of a plurality of wavelength separators; and

FIG. 13 shows a further embodiment of the invention.

### DETAILED DESCRIPTION OF PREFERRED EMBODIMENTS

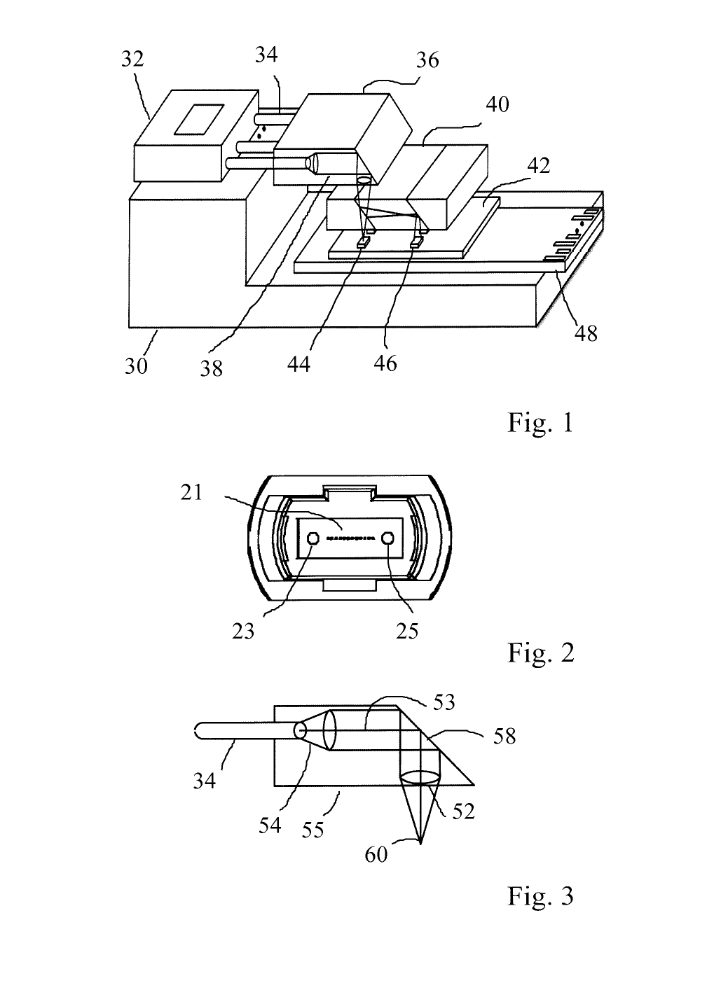

FIG. 1 illustrates an array-based solution for a plurality of integrated bidirectional transceivers with sub-elements according to the invention. The sub-system shown will in general form part of or be placed in or adjacent to a central station. Block 30 is a sub-assembly: a mounting base or package for the device. The actual fibers are referenced 34 and issue from a block 32, see also FIG. 2. Block 36 is an optical coupling element that comprises symbolically indicated optical components, which will be described in more detail further below. Block 40 is a wavelength divider, also denoted WDM (Wavelength Division Multiplexer). Block 42 is an optical platform that supports radiation sources (lasers) 44 and photodetectors 46. Block 48 is a printed circuit board (PCB) with electrical or electronic connectors to the outer world. In a direction transverse to the drawing as shown there is usually a uniform pitch between the consecutive radiation paths, the ratio thereof being equal to the pitch of consecutive fibers in the beam 34. It is possible in principle that a pitch is realized between the fibers 34 different from that of other parts of the assembly.

In particular, the glass fibers of the row are at exactly defined distances. They are coupled to a system of lenses (see 38) that maintains the relative distances between the various channels. The radiation of this block 36 is coupled into a wavelength divider block 40 which separates the transmission wavelength and the reception wavelength for the entire row of channels. These separated channels are coupled to radiation sources 44 for the transmission and to photodetectors 46 for the reception of the respective specific wavelengths of the radiation.

It is true for both the radiation sources and the photodetectors that they may be constructed from discrete elements or as arrays of which the pitch is already correct. The radiation from the radiation sources is preferably used for aligning. At least two radiation sources, which are both aligned, are then required for the aligning process of an entire array. These two are preferably the outermost two. A fixed scale factor may be incorporated between the pitches of channel portions in special cases.

FIG. 2 shows a 12-fold MPO connector with MT ferrule in front elevation, i.e. the channels are directed transversely to the plane of drawing and are referenced 21. The distance between consecutive fibers, i.e. the pitch, is typically 250 +/− 1 μm. Elements 23 and 25 are, for example, pins that fit into recesses of an oppositely located connector. Further elements shown do not have a direct bearing on the invention. The material of the ferrule may be, for example, synthetic resin reinforced with embedded glass particles. Such materials are easy to process, for example by polishing down to a smooth surface in which the glass fibers are embedded. The word “ferrule” is standard in this technology.

FIG. 3 shows part of an optical coupling element 55 with an incorporated angle and an optical radiation axis 53. The element 60 is, for example, a radiation source and the element 34 the wave-guiding fiber. The coupling element comprises an optical element 58 which is a reflecting or focusing mirror. The coupling element complies with the requirement that the pitch of the consecutive radiation beams should be maintained. This pitch may be increased or decreased, if so desired, as long as a predefined relation and the accompanying accuracy remain intact between all pairs of fibers.

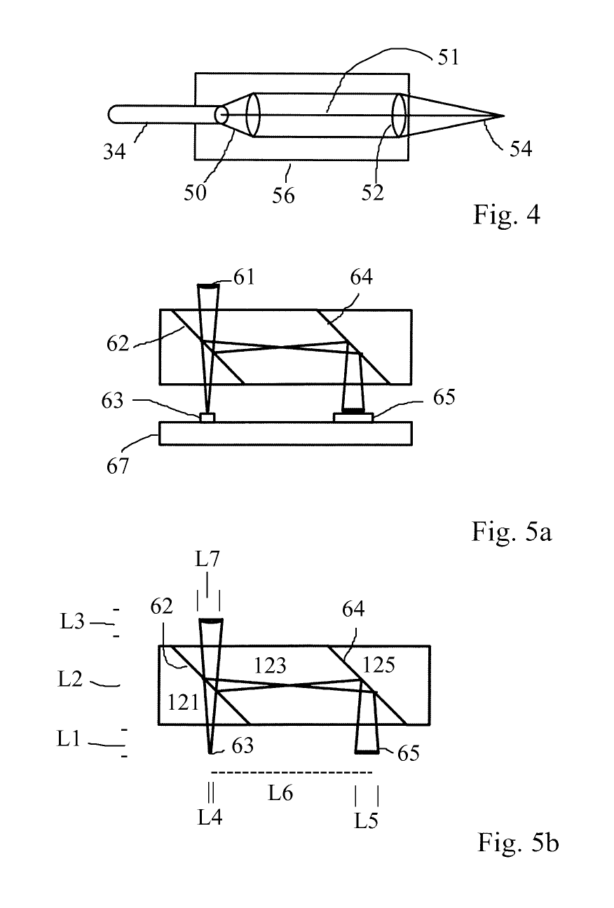

FIG. 4 shows an optical coupling element with a rectilinear path along a central radiation axis 51. Glass fibers 34 herein emit an array of diverging radiation beams. The diverging beams are collimated within the housing 56 into points of convergence 54 by optical elements 50, 52 for each fiber. FIGS. 5a, 5b show a micro-optical wavelength separator. Multiplexing in accordance with a division of wavelengths takes place in a separate block by means of a mirror 62 which transmits one wavelength from the radiation source 63 in upward direction in FIG. 5a while reflecting the other wavelength received from the upward direction to the right towards detector 65. A second mirror 64 achieves a comparatively great displacement between the downstream (63) and upstream (65) radiation. The ends of the two beams lie in the plane of the optical platform 42 of FIG. 1. The inventors have recognized that the radiation source should accordingly be comparatively accurately focused on the optical coupling element. A vertical laser is preferably used as the radiation source, such as a VCSEL (Vertical Cavity Surface Emitting Laser). The beam divergence thereof is smaller than that of conventional lasers such as a DFB (Distributed FeedBack) or FP (Fabry Perot) laser. Furthermore, a vertical laser may be provided on the optical platform 42 (FIG. 1) in a simple manner, given a radiation beam radiating in vertical direction thereon. The interrelationship between respective radiation beams is not, or only slightly, disturbed by the configuration of the sub-elements of FIGS. 5a, 5b. In particular, FIG. 5a further comprises an optical platform 67 on/in which radiation sources and photodetectors are provided. This platform has been omitted in FIG. 5b. Said platform is also present in various further Figures for the sake of clarity, whereas the version corresponding to FIG. 5b is generally not shown each time. The dimensions L1, L2, and L3 indicated in FIG. 5b are 100, 300, and 100 μm, respectively, in the present example. L4 is 6 μm and L5 is 68 μm, while L7 is 84 μm. L6 is 500 μm here.

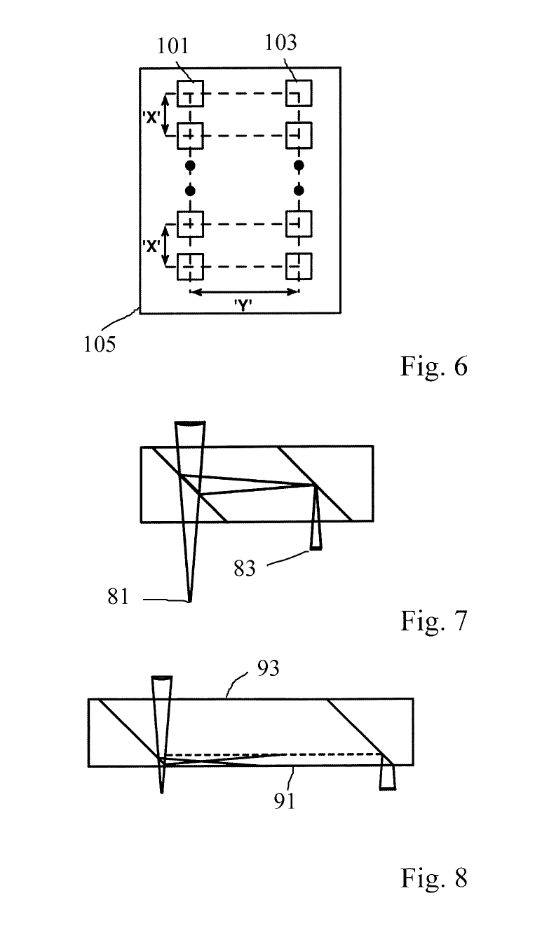

FIG. 6 is a plan view of an optical platform such as the element 42 of FIG. 1. Vertical lasers 101 and associated transmitter control electronics as well as photodetectors 103 and associated receiver control electronics are preferably placed thereon in one and the same plane 105. These elements are placed each in a respective one of the arrays of radiation sources and detectors. The radiation sources have a defined pitch X which here corresponds to the pitch of the photodetectors. The distance between the array of radiation sources and the array of photodetectors is also defined. The radiation beam is incident in a diverging manner on the larger active region of the photodetectors of, for example, up to 80 μm. The alignment tolerance may accordingly be of the order of approximately 10 μm. Owing to the smaller active region of approximately 6 μm of the lasers, the alignment tolerance for these is of the order of 1 μm. The control electronics have been arranged on the oppositely located pc board 48 in the embodiment of FIG. 1, and the optical platform in principle comprises only those elements which provide the electro-optical conversion (the radiation sources and the photo detectors).

A number of design aspects of the micro-optical wavelength separators will now first be discussed. In general, the signal to be received from the optical coupling element has a wavelength different from that of the signal to be transmitted. A wavelength separating element according to the invention as described herein renders it possible to separate the received radiation signals. The wavelength separating element will thus comply with the following specifications:
a. the different wavelengths for the signal to be received and the signal to be transmitted are incident on a surface with a predefined distance between these wavelengths;
b. the tolerance is comparatively wide in the x, y, and z directions owing to the shape of the element;
c. it is possible to carry out the procedure for an array of signals.

The element shown by way of example in FIGS. 5a, 5b is based on a radiation source with an intensity halving value at, for example, 9° relative to the maximum (FWHM) of the radiation source. This is a typical value for a VCSEL (Vertical Cavity Surface Emitting Laser). The FWHM value of other types, such as FP (Fabry-Perot) lasers, is often much higher, which limits the application possibilities thereof.

Since the lens in the optical coupling element is designed such that the radiation from the radiation source is optimally captured, the received signal will arrive at the detector in an unfocused state. This, however, is not a critical disadvantage because the photodetector has a much larger active surface than the radiation source.

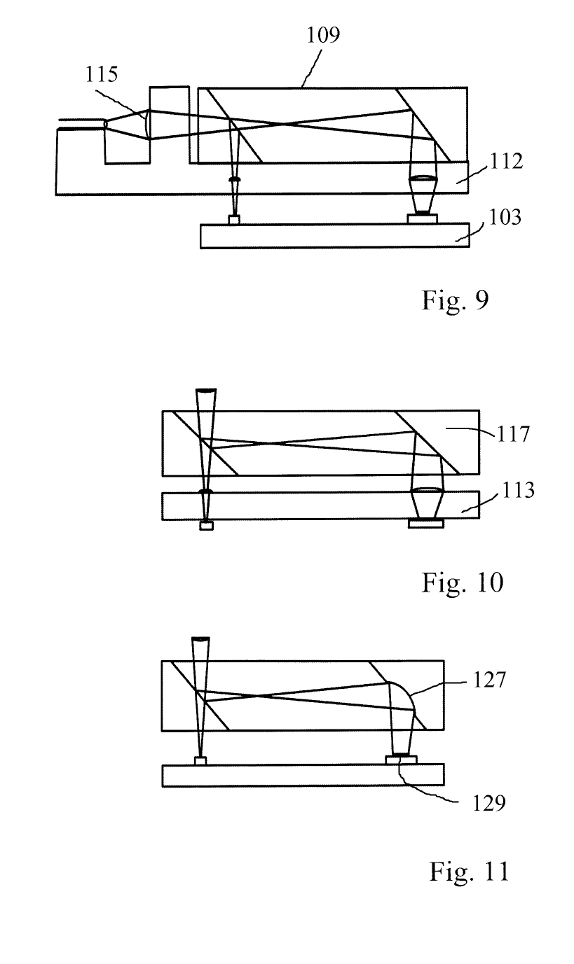

The distance between the active region of a radiation source and the associated photodetector must be sufficiently great for the radiation sources and detectors to be positioned. This will mean a distance of approximately 1 mm in practice. Given a radiation angle of the radiation sources as mentioned above and an active region of the laser of 6 μm (typical value), a spot of 152 μm will be incident. Certain detectors have an active region of only 80 μm. The problem of a too wide radiation beam may be solved in the following manners:
1. Reducing the distance between radiation source and detector; cf. the dimensions given in FIG. 5a/5b for this, where the received radiation spot has a diameter of approximately 68 μm. FIG. 5a provides an additional optical platform 67 in this respect, on which the radiation sources 63 and photodetectors 65 are mounted. Such a shared platform is not present in FIG. 5b. It also holds for other embodiments to be discussed below that the shared optical platform may or may not be present.
2. Providing a difference in height between the radiation source 81 and the detector 83 with dimensions as shown, for example, in FIG. 7. The laser 81 will be at a lower level in this arrangement, in the present example 400 μm lower (500 μm-100 μm). The other elements of FIG. 7 correspond to those of FIG. 5b.
3. Using waveguides 91 in the micro-optical wavelength separators with a configuration as shown in FIG. 8; the waveguides 91 are provided in the wavelength separator. The spot size now becomes independent of the distance between the radiation source and the detector. Non-limitative preferred widths for the waveguide are between 30 and 50 μm. The required positioning accuracy for the wavelength separator becomes approximately 10 μm in many cases. The vertical distance is limited by the spot size on the optical coupling element. The arrangement of FIG. 8 further comprises the same elements as FIG. 5b.
4a. FIG. 9 shows a modification of the optical coupling element (112). The wavelength separator here is an interposed element. This embodiment has the advantage that an extra array of lenses is available for optimally imaging the radiation beams on the radiation sources and photodetectors. The radiation sources and photodetectors are mounted on a plate 103 here.
4b. Performing a wavelength separation in a wavelength separator 117 as shown in FIG. 10, with a transparent optical platform 113 with an integrated additional lens system, on which platform the radiation sources and photodetectors are also accommodated. Lenses may be present adjacent the radiation sources and/or the photodetectors.
4c. Imaging the received radiation on the detectors 129 by means of a focusing mirror 121 as shown in FIG. 11.

The wavelength separating element may be mechanically realized in a variety of advantageous manners. If the incoming radiation is incident transversely to the optical platform, three transparent bodies 121, 123, 125 may be joined together from left to right, as shown in FIG. 5, with a thin wavelength separating coating between the first two bodies and a separating layer that provides a sufficiently full reflection between the second and the third body.

The same result can be obtained if the radiation arrives substantially parallel to the plane of the optical platform. The wavelength separator is independent of the radiation direction.

The above can also be realized in a configuration in which the third body 125 is omitted, in which case the total reflection takes place at an external surface.

The above can also be realized in a configuration in which the first body 121 is omitted, so that the frequency-specific reflection takes place at an external surface. The latter two modifications may obviously be combined with each other.

The full reflection may be realized by means of a suitable coating layer. Another possibility is the use of inherent total reflection. In that case the intermediate body 123 may have upper or lower surfaces which are mutually parallel but which enclose an angle with the plane of the optical platform.

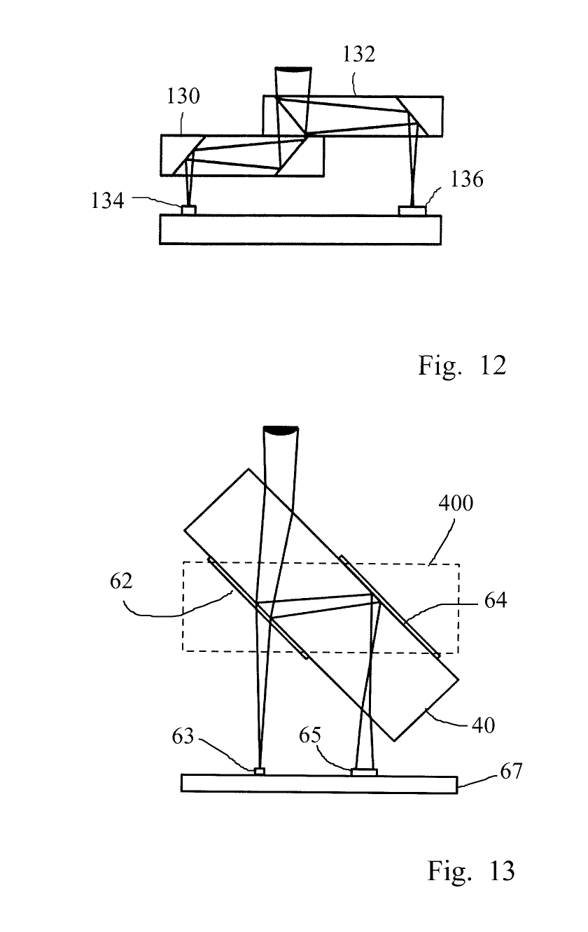

FIG. 12 shows a further embodiment with a combination of several wavelength separating blocks 130, 132, through which the radiation beam from the radiation source 134 and the radiation beam for the photodetector 136 are guided separately. This leads to a greater spatial distance between the radiation sources and the photodetectors. The radiation source may be positioned on the left (or possibly on the right) in this Figure, and the photodetector on the right (or possibly on the left), also in dependence on the coating of the two wavelength separating elements. Both the radiation source and the photodetector may be put into focus in this manner. This, however, is not necessary.

FIG. 13 shows a further embodiment of the invention. In this embodiment, the wavelength separating block 40 is at an oblique angle relative to the radiation beams. A wavelength separating block 400 is shown in broken lines for comparison, having a straighter position as corresponding to FIGS. 5a, 5b. The various components of this embodiment have been given the same reference numerals as in the embodiments of these latter Figures. A major advantage of this embodiment—as indeed of other embodiments of an optoelectronic device according to the invention—is that the radiation beams coming from the source 63 and incident on the detector 65 and the beam issuing from the block 40 are all at least substantially perpendicular to the mounting surface 67 on which the radiation sources and photodetectors are mounted. Such a mounting surface may also be denoted “optical platform”. This facilitates a reliable implementation of the device according to the invention. Another major advantage of this embodiment is that the manufacture of components thereof, in particular those of the wavelength separating block 40, is easy and comparatively inexpensive. A large number of blocks may be readily manufactured next to one another in a planar (transparent) plate, which for this purpose is provided with the filter 62 and the mirror 64 on either side. This may be achieved in that the two sides of the plate are coated with a mirroring/filtering layer which is subsequently patterned by means of photolithography. Alternative lithographic techniques may also be used, such as the so-termed lift-off technique. The individual wavelength separating blocks 40 may subsequently be obtained by means of a separating technique such as sawing.

1. An optoelectronic device for bidirectionally transporting information through glass fibers between logically distributed users and a central station by means of transceivers of said central station,
characterized in that a set of several glass fibers is connected in an array having a predetermined pitch to a multiple-operation coupling element that is provided with lenses and that guides the downstream and upstream radiations from the glass fibers through a multiple-operation wavelength divider which effects a spatial separation between the downstream and upstream radiations such that said downstream and upstream radiations are imaged on radiation sources and photodetectors, respectively, said radiation sources being spatially separated from said photodetectors.

2. An optoelectronic device as claimed in claim 1, wherein said radiation sources and/or photodetectors are positioned by means of a carrier on a photo-electrical connection element for said central station.

3. An optoelectronic device as claimed in claim 1, wherein said photodetectors are all mutually inherently aligned when the radiation sources are aligned relative to said array of glass fibers.

4. An optoelectronic device as claimed in claim 1, wherein said radiation sources and photodetectors are fixed on a carrier at fixed and substantially uniform distances to one another.

5. An optoelectronic device as claimed in claim 1, wherein said radiation sources and photodetectors are fixed substantially in one plane on a carrier.

6. An optoelectronic device as claimed in claim 1, wherein said radiation sources are constructed as vertical lasers.

7. An optoelectronic device as claimed in claim 1, wherein the radiation sources are located substantially in the focal points of the respective lenses, while the associated photodetectors are located out of focus, i.e. further removed than said focal points.

8. An optoelectronic device as claimed in claim 1, wherein a transparent optical platform with lenses is placed between the plane of the wavelength separators and the radiation sources/photodetectors for adapting the radiation beam of the downstream and/or upstream radiation.

9. An optoelectronic device as claimed in claim 1, wherein the radiation sources and photodetectors differ in height so as to adapt the dimensions of the received radiation beam to the dimensions of the photodetectors.

10. An optoelectronic device as claimed in claim 1, wherein waveguides are arranged between said wavelength separators and the photodetectors for adapting the radiation beam of the upstream radiation.

11. An optoelectronic device as claimed in claim 1, wherein focusing mirrors are arranged between the wavelength separators and the photodetectors.

12. An optoelectronic device as claimed in claim 1, wherein the wavelength separator comprises, optically connected in series in that order, a filter relative to a first wavelength and a mirror relative to a second wavelength, and the radiation beams issuing from or entering the wavelength separator are substantially perpendicular to a mounting surface of the radiation sources and photodetectors.

13. An optoelectronic device as claimed in claim 12, wherein the wavelength separator is at an oblique angle to said radiation beams and said mounting surface.

14. A method of manufacturing an optoelectronic device for bidirectionally transporting information through glass fibers between logically distributed users and a central station by means of transceivers of said central station,
characterized in that a set of several glass fibers is connected in an array having a predetermined pitch to a multiple-operation coupling element that is provided with lenses and that guides the downstream and upstream radiations from the glass fibers through a multiple-operation wavelength divider which effects a spatial separation between the downstream and upstream radiations such that said downstream and upstream radiations are imaged on radiation sources and photodetectors, respectively, said radiation sources being spatially separated from said photodetectors.
